(19) United States
(12) Patent Application Publication
(10) Pub. No.: US 2024/0070529 A1
(43) Pub. Date: Feb. 29, 2024

(54) ARTIFICIAL INTELLIGENCE OPERATIONS MANAGER SYSTEM AND METHOD

(71) Applicant: MATTHEW WAMPLER, COLLEGEVILLE, PA (US)

(72) Inventor: MATTHEW WAMPLER, COLLEGEVILLE, PA (US)

(21) Appl. No.: 17/949,021

(22) Filed: Sep. 20, 2022

Related U.S. Application Data
(60) Provisional application No. 63/246,494, filed on Sep. 21, 2021.

(51) Int. Cl. G06N 20/00; G06Q 50/12

(52) U.S. Cl. CPC G06N 20/00; G06Q 50/12

(57) ABSTRACT

An artificial intelligence operations manager has at least one computer processor operable with a memory storage medium. An inventory manager program tracks selected inventory data from at least one operational unit for comparison with operational performance thresholds. At least one or more of a manual inventory level and automated inventory level input interface automates inventory levels and changes to those levels. A data queue used by the inventory manager program to arrange inventory management tasks according to selected operational performance thresholds to recommend and monitor inventory level changes. A machine learning program supporting the inventory management program further assesses data from the data queue and operational thresholds, wherein the machine learning program improves the cost, pace, and quality of inventory management performance by optimizing inventory level changes required to handle deviations from inventory use predictions, improving the accuracy of inventory use predictions, and recommending inventory use promotions.

### CLAIM OF PRIORITY

This application is a continuation-in-part of U.S. Provisional application patent application with Ser. No. 63/246,494, filed on 21 Sep. 2021, which is incorporated herein by reference in their entireties.

### FIELD OF THE INVENTION

The inventive concept relates generally to an artificial intelligence operations manager system and method for inventory management.

### BACKGROUND

Franchised restaurants are ubiquitous throughout the US economy. In the franchise system, a franchisor provides brand recognition, systems and procedures, contract pricing, and marketing support, in exchange for a percent of all revenues (typically ˜7%), while a franchisee will operate the physical restaurant location. In many cases, the savings on food costs through contract pricing make up for a large portion of the royalty costs. Support and resources provided by franchisors vary. Recent court cases have begun to target franchisors, in cases focusing on questions relating to the amount of control that these entities exert over the business operations of their franchisees, thereby opening the franchisor up to litigation brought against a franchise. As a result, franchisors have grown increasingly reluctant to provide guidance on many pivotal aspects of a franchisee's operations. It is incumbent upon franchisees to handle functions such as pricing, labor, HR, accounting, among others, at their sole discretion. Additionally, franchisors and franchisees derive profit differently. Franchisors receive a percentage of top line revenue from a franchisee, while a franchisee operates to maximize bottom line profits. These differing motivations can lead to inefficiencies when it comes to areas such as staffing and waste.

Restaurants often operate on thin margins-10% on average. Operators who can manage costs well may generate margins closer to 25%, while others either lose money or have below-average margins. Cost of goods sold (COGS) and labor generally constitute 50%-70% of operating expenses, and each of these items is heavily affected by forecasted sales. Franchisees make up their own forecasts and often do so inaccurately. When these forecasts are higher than actual sales, food may be wasted, and the restaurant may be overstaffed. When low, franchisees may run out of product, provide poor service, and may lose customers.

Forecasting sales at franchise restaurants can be difficult. Sales fluctuate daily, and customer tastes change over time. Poor customer service at restaurant locations can cause steep declines in sales. Positive and negative variables effecting sales impact each unit differently, making a single forecasting method for every location a weak predictor of performance at a specific location. The combination of the franchisee-franchisor relationship, fluctuating traffic, and relatively unique demand patterns for each location, causes substantial hurdles for controlling the most pivotal cost drivers of a restaurant's operations.

Most franchisees use a simple formula to forecast sales at each of their restaurant locations. Commonly, and for illustration, this formula involves taking the last 4 weeks of revenues of a shift being forecasted, subtracting out catering where present, calculating the mean, then adding a buffer, for example 20%. Franchisees may also lack a central platform designed to house and support their many data and forecasting needs. Items such as forecasting, scheduling, and tracking are often performed on a spreadsheet. Data reporting may be done through portals providing limited capabilities.

Many platforms exist for franchise restaurants and restaurants in general, but the one-size-fits all options provide general data while lacking brand-specific guidance such as accurate forecasting. Therefore, there is a need in the market for an improved forecasting system and method so restaurant operators can operate independently without requiring a deep background in data analytics. Artificial intelligence provides an avenue for improvement.

Artificial Intelligence “AI” is the concept of creating intelligent machines that can simulate at least some aspects of human thinking capability and behavior. AI is a subset of computer science and data science, and AI includes machine learning. Many AI applications improve operational performance of enterprises and their suppliers in the restaurant industry such as aiding to better target customers, develop menus, optimize logistics, and forecast the behavior of individuals and groups anywhere in the supply chain up to consumption. However, the use of AI is limited by the need for statistical and coding knowledge required to apply AI output and to ensure the data assessed is optimized for the sought output. Because most restaurant operators lack skills to code or apply statistics, they often lack the ability to create a custom AI optimized for their businesses, the needs of each business varying even from otherwise identical operations due to differences in location, timing of customer flow, access to supplies, and other risks such as weather and vehicular traffic. Therefore, there is a need for an AI solution designed to allow users who may know how to run their businesses but who may lack enough understanding of statistics and coding to use AI and optimized AI to support reaching specific goals and constraints of their restaurant businesses. This need may extend to other businesses in other industries experiencing similar challenges.

### SUMMARY OF THE INVENTION

An artificial intelligence operations manager (AIOM) disclosed herein improves the capacity for a given user to use machine learning when operating a restaurant or other enterprise by limiting the statistical and coding skills required from the given user when seeking results from machine learning. The inventive concept has at least one computer processor operable with a memory storage medium. An inventory manager program tracks selected inventory from at least one operational unit for comparison with operational performance thresholds, the inventory manager program further designed to receive data about inventory availability and logistical accessibility at least one or more of outside and inside at least one operational unit. An example operational unit is a franchised restaurant but may be an independent restaurant, a chain restaurant, or another business having a typically daily flow of inventory wherein at least some of that inventory is perishable within days or fractions of days of availability for consumer purchase.

The inventive concept includes at least one or more of a manual inventory level and automated inventory level input interface to the inventory manager for the at least one operational unit, the automated inventory level input further having at least one sensor determining at least one or more of inventory level, the withdrawal of inventory, and the addition of inventory. Such sensors may detect at least one or more of weight cues, optical cues, tag cues such as RFID and optical codes, image cues such as an image of the inventory itself, gate cues such as inventory passing through a door or light beam, inventory scanners, point-of-sale scanners, automated purchase scanners such as Amazon Go, and other ways to count inventory, including those built into a smartphone or tablet.

A data queue used by the inventory management program to arrange inventory management tasks according to selected operational performance thresholds wherein the decision to change inventory levels within one or more operational cycles considers at least the cost and benefit of changing inventory levels to one or more selected levels of change compared to the cost and consequences of leaving inventory levels unchanged, the data queue further used to arrange inventory management tasks based either or both on changing individual inventory item levels and changing substantially together levels of two or more inventory items.

A machine learning program supports the inventory management program and is designed to, on a substantially continual cycle, at least one or more of assess data from the data queue and operational performance thresholds, recommend inventory management changes to either or both at least one human or at least one machine, monitor inventory management actions taken from recommendations by the at least one or more of the at least one human and the at least one machine. The machine learning program adapts its performance to improve the cost, pace, and quality of inventory management performance by optimizing inventory level changes required to handle deviations from inventory use predictions. The machine learning program improves the accuracy of inventory use predictions and may recommend inventory use promotions whereby changes in inventory use requests improve prediction accuracy.

In one embodiment of the AIOM, a user may set operational goals via a dashboard assembly through which to orient the inventory management program and the associated machine learning program wherein the selection of operational goals may be either or both manually set or set with machine assistance, and where the goals include, but are not limited to, controlling costs and optimizing inventory availability.

In one embodiment of the AIOM, the AIOM further renders controllable at least one or more equipment members, the equipment members having at least one computer processor operable with a memory storage medium, the AIOM designed to either or both control and advise on equipment member performance to further optimize the use of resources. An equipment member could include, but is not limited to, such items as refrigerators, freezers, ovens, buffet kiosks, coffee dispensers, soda dispensers, mixers, vats, washers, point-of-sale systems, vending machines, and other items that may be used directly for storing, moving, and preparing inventory or indirectly to support operations. One of ordinary skill in the art would recognize that equipment members may be a part of the Internet of Things (IoT). The IoT describes the network of physical objects, so known as, “things,” that are embedded with sensors, software, and other technologies used to connect and exchange data with other devices and systems over the Internet.

The AIOM can be networked beyond a single operational unit to many operational units, equipment members within those operational units, and may be further networked into logistics units, sources of supply, and sources of production, as well as to people and machines associated with such elements.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a representative artificial intelligence operation management system (AIOM);

FIG. 2 illustrates a computer processor operable with a memory storage medium;

FIG. 3 illustrates representative AIOM controls;

FIG. 4 illustrates a representative data feed and user preference learning model;

FIG. 5 illustrates a representative forecast model;

FIG. 6 illustrates a representative notification protocol model;

FIG. 7 illustrates a representative product management model;

FIG. 8 illustrates a representative stock-out analysis model;

FIG. 9 illustrates a representative intra-day reporting schedule model;

FIG. 10 illustrates a representative platform overview model;

FIG. 11 illustrates a representative staffing model;

FIG. 12 illustrates a representative staffing overview;

FIG. 13 illustrates a representative start and end day reporting model;

FIG. 14 illustrates a representative schedule output;

FIG. 15 illustrates a representative store manager dashboard;

FIG. 16 illustrates representative sales reporting;

FIG. 17 illustrates the AIOM within a broader supply chain;

FIG. 18A-18C illustrates a representative method for using the AIOM.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The disclosed inventive concept allows users with limited statistics and coding skills to use artificial intelligence (AI) and optimized AI to the specific goals and constraints of their businesses. It presents, therefore, a user-friendly system and method designed especially for those users lacking statistics and coding skills when compared to forecasting systems that require statistics and coding skills. The inventive concept digitizes, automates, and optimizes the operations of the given user aimed toward meeting desired standards via software operating from at least one computer system wherein the given user creates an AI decision support system for their business. This aim is accomplished through software that allows for the given user to create their own Artificial Intelligence Operations Manager (AIOM). Furthermore, it provides a plurality of system access points through which users may interact with the AIOM and the AIOM may interact with the users wherein the AIOM may include grades of system interaction depending on the need and skill of the given user.

The terms optimal and optimize, in this disclosure, are defined as a balance between two measures of a given value where too high or too low a value may otherwise be detrimental. For illustration, a franchise could have too much bread on hand, resulting in waste when bread goes unsold, or too little bread on hand, resulting in inventory running out. An optimal amount of bread would be to have exactly the needed supply on hand, no customer going without and no bread going unsold. AIOM can address both supply and demand to help an enterprise optimize inventory.

The given user has the option to perform some tasks manually, leave some tasks to be handled autonomously, and have some tasks handled manually but aided by the AIOM, noting the added benefit that AIOM can perform tasks in parallel that, if performed manually, would be performed substantially sequentially per each task delegated to a person.

The inventive concept further considers aspects of constraints pertaining to space, time, materials, and risk wherein these constraints may relate to other constraints. For example, use of certain materials such as bread, which may require resupply during an operational day, must be calculated and estimated by a certain time in that day given the lead times required to act on the request, a time which may vary by enterprise depending on the comparative challenges of accessing resupply materials. For illustration, while one AIOM may achieve the best results for its users via resupply of materials because of ready access to materials, another may achieve better results for its users via daily sales promotion strategies that change the likelihood customers will buy one inventory item versus other inventory items because materials are comparatively difficult to access for resupply.

The AIOM would analyze data such as the average time between reorder and delivery inclusive of useful granularities such as the average time of delivery for a morning order or an afternoon order, such data providing a way to determine internal constraints. Further, AIOM may consider when partial resupplies of materials may be the best possible option if, for example, a partial resupply is within comparatively easier access than a full resupply, but the partial resupply would limit the impact of running out or raise the probability that a promotions strategy could produce enough impact to make up the difference from a partial resupply. Further, the AIOM may consider when obtaining and using a substitute material may be a best-case option, for example, when a frozen or canned food might be a better solution than running out of that food if fresh examples of the same run out and how to preposition such substitutes, for example, having a backup supply of canned of frozen food in an available space to counter some variances.

In one exemplary embodiment, the given user sets up the AIOM through inputting their desired operational outcomes through such tabulations as:
Setting Key Performance Indicators (KPIs)
Determining acceptable operational performance thresholds
Prioritizing the importance of data
Establishing the best channels of communication for users and for the data

For an example of the latter, data, AIOM may require manual data input by the given user directly, such as recording the consumption of a good, or indirectly, such as calculating consumption from point-of-sale (POS) data as a transaction for the good, and, therefore, inventory takes place. On the other end of the spectrum, systems using the Internet of Things (IoT) may communicate consumption information directly with the AIOM with no or minimal human input. The AIOM automates and optimizes performance by such exemplary ways as:
Connecting to the given user's operational data.
Storing, maintaining, and organizing the data.
Applying machine learning tools and simulation models to facilitate desired KPI's of the given user, including but not limited to decision trees, neural networks, Bayesian models, and genetic algorithms. The decision trees, neural networks, Bayesian models, and genetic algorithms may, in some embodiments, be derived from preset or partially preset libraries.
Monitoring the KPI's of the given user's operations at set periods through each operational cycle, the periods which may be set for substantially continuous monitoring.
Assessing the importance of events for the given user and when thresholds have or may be reached to trigger decisions or actions along with thresholds of criticality.
If an operational issue is identified, determining if a solution is available through which to improve the outcome over a present results trajectory, and if there is more than one solution, the comparative benefits and drawbacks of the solutions.
Determining who and where the relevant parties are for making decisions and taking actions along with the optimal way to communicate with those parties.
Facilitating and distributing a plan of action to those involved in operations, these being in the form of instructions, recommendations, or both.
Monitoring issue resolution to help ensure resolution completion.
Providing users with a view into operational and sales data to help users to monitor their KPI's themselves and continue to improve and change the AIOM
Leveraging the ability to control a vast array of operational goals and systems without the need for technical knowledge
Leveraging the option to use a dashboard or system platform designed to allow users to set operational goals and milestones, which are then translated into programming language and optimized using machine learning and other tools, where the direction, generally, is to build systems of operation that make obtaining goals a greater probability than without the associated machine learning.
Permitting users to choose and rank inventory items of importance, having those items monitored throughout the supply chain, with the system automatically sending selected alerts to either or both people and machines throughout the operation, and providing guidance to ensure the availability of those items.
Deploying machine learning models to optimize staffing, inventory, preparation, and other operational objectives without the given user requiring coding or technical knowledge.
Systematically quantifying real-time and potential operational issues.
Translating complex multi-variable decisions (where the given user might traditionally depend on intuition), automatically framed into clear business style cost and benefit analyses, where users can apply their knowledge and desires to achieve useful results.
Allowing for the human dimension wherein the given user prefers to manage by intuition, the AIOM framing its recommendations as decisions for the given user to approve instead of decisions for the given user to obey, thereby allowing the AIOM to become an advisor through which the given user can double-check intuition.

The application and associated interface may contain an information section that incorporates infinite scroll and data organized by the AIOM. The AIOM may include buttons, icons, or both, which allow users to trigger reminders, warnings, and notifications on the data provided on the infinite scroll. The interactions with the infinite scroll will help train the AIOM on what is important and what to automate in the future.

One of ordinary skill in the art would recognize that numerous data sources, rules, weights, and variables may be incorporated by machine learning to optimize such AIOM outcomes disclosed herein, and that inherent in the inventive concept is the use of machine learning to select and optimize those data sources, rules, weights, and variables as they pertain to the given user. These data sources, rules, weights, and variables pertain to operational performance measures inclusive of time, space, material, and risk as each of these performance measures are defined by the given user. For illustration, risk may have many variables such as the cost of wasted goods if oversupplied and the cost of diminished customer satisfaction if goods run out where machine learning aids on handling uncertainties associated with benefits minus costs equals value as the business seeks to have neither too much nor too little inventory on hand. These performance measures may be considered at a given moment in time. Change and rates of change may also be derived from the data in the intervals and fractions of intervals measured. Machine learning will consider operational strategy to optimize performance, therefore, aiding the given user at focusing effort, economizing resources, retaining freedom of action, and minimizing risk, these being operational imperatives of a restaurant and other businesses supportable by the inventive concept.

Training machine learning algorithms necessarily requires training data, test data, and actionable data, the algorithms used to optimize inventory levels for at least one or more of individual items and aggregates of more than one item. Operational strategy takes place within definable decision cycles wherein at least one or more of the given user and the AIOM makes assessments, makes decisions from those assessments, takes action, manages action, measures results, makes new assessments, makes new decisions, takes new actions, and so on, the cycle repeating and branching off as conducive to the matter triggering the initial assessment, the whole oriented on the given user's definition of a successful operation at given operational units, a definition that itself may evolve and be optimized by either or both people and machines. The inventive concept may train machine learning in simulated environments where a computer system emulates the operation of one or more operational units such as a franchise restaurant and may include all or part of an entire supply chain. In this way, the AIOM may, for example, learn to optimize the performance of a simulated operational unit in place of an actual operational unit.

The AIOM itself may involve 1) optimizing operations for the given user wherein the direction of optimization is to improve benefits while minimizing drawbacks, for example, allowing the given user to adjust performance thresholds without requiring the given user to code the adjustments, and 2) optimizing the AIOM to achieve desired results with minimal resources.

The inventive concept may be optimized for restaurants wherein the machine learning accounts for durable ingredients, such as sugar, perishable ingredients, such as bread, and items that may become more perishable than otherwise once processed, such as baked bread. The AIOM may optimize the inventory present and the preparation of that inventory to another one or more stages, such as mixing and cooking, wherein the inventive concept applies these layers to the time, space, material, and risk associated with the associated inventory. For illustration, one set of variables and weights may be applied to steak when the steak is frozen, another set of variables and weights when the AIOM triggers the need to thaw the steak given the steak's higher perishability once thawed, and another set of variables and weights when the steak is cooked given its still higher perishability the moment cooking has been completed. Subjective measures may be included for the AIOM to assess, such as the impact of customers if a given ingredient runs out or takes longer than expected to receive, such data obtained directly, as may be performed through surveys, or indirectly, as may be obtained by recording the probable cause for a low tip or customer complaint. Inherent within the AIOM is the ability to use data for machine learning and to either or both assess the quality of the data and have the quality of the data assessed, as well as to assess whether AIOM optimizations for one operational unit are relevant to another operational unit.

The inventive concept may further use the AIOM to optimize staffing requirements such as hours, problem solve for operational issues, and manage performance goals, particularly as these requirements impact inventory supply, use, and pace of use.

Optimize is generally a condition of best or most effective use and may involve tradeoffs between more than one variable, such as balancing the cost of carrying too much inventory weighed against the risk of inventory running out. Resources include inventory and may include other items related to inventory such as staffing, time, energy, money, and other items the use and non-use of which may cost money. Level can be inventory item quantity and may also be other measures such as inventory weight, inventory volume, or a state of that inventory, for example, from uncooked to cooked.

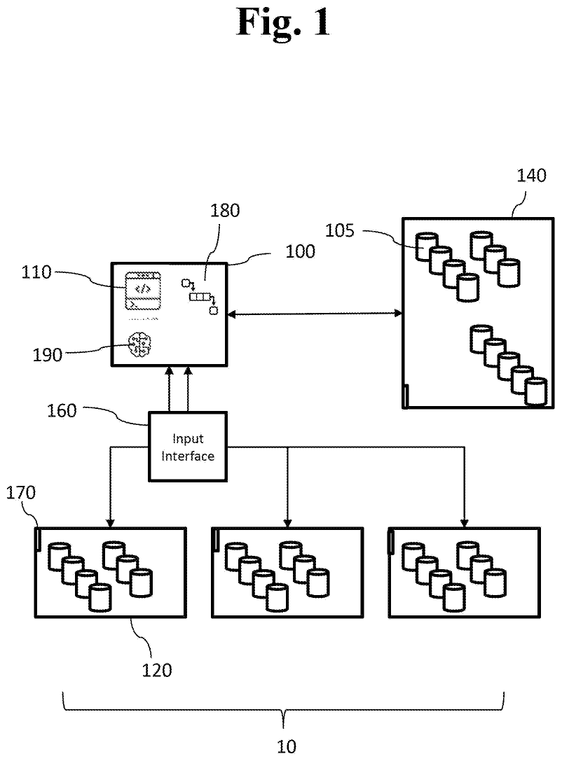

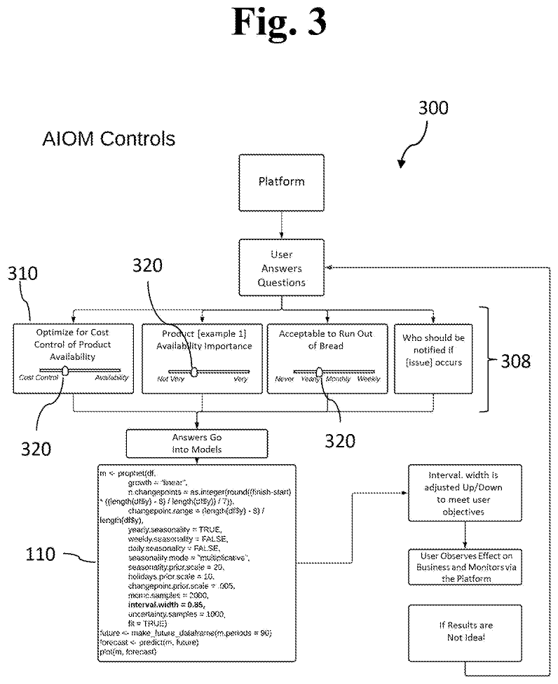

FIG. 1 illustrates an exemplary artificial intelligence operations manager AIOM 10 having at least one computer processor operable with a memory storage medium 100, the AIOM 10 designed to replace depleted inventory 105 for at least one operational unit 120 from an at least one supply unit 140. An inventory manager program 110 tracks the inventory 105 and may track the state of that inventory 105 within at least one operational unit 120 for comparison with, as illustrated in FIG. 3, operational performance thresholds 308, the inventory manager program 110 further designed to receive data about inventory availability and logistical accessibility of that inventory 105 from the at least one supply unit 140 at least one or more of outside and inside at least one operational unit 120.

FIG. 1 further illustrates that the inventive concept includes at least one or more of a manual inventory level and automated inventory level input interface 160 to the inventory manager program 110 for the at least one operational unit 120, the automated inventory level input interface 160 further operationally coupled to at least one sensor 170 within at least one operational unit 120 determining at least one or more of inventory level, the withdrawal of inventory 105, and the addition of inventory 105, the at least one sensor 170 allowing for measuring the passage of elements through the inventive concept to determine which inventory management actions to take with respect particularly to forecasted sales at the at least one operational unit 120 and inventory level requirements necessary to handle deviations from the forecasted sales.

FIG. 1 further illustrates that each given sensor 170 is designed to detect at least one or more of inventory availability, use, a condition of the inventory, and a condition of the environment, each related to the availability of the inventory through time. Sensors 170 may further compensate for user shortcomings by providing the inventive concept with the capacity to monitor either or both itself and its environment. In some embodiments, for example, sensors 170 may exist to detect inventory quantity, other exemplary sensors 170 may detect inventory weight or volume, other sensors 170 may detect a chemical signature such as ethylene associated with ripeness, and still other sensors 170 may detect temperature and consistency of temperature as needed to meet both practical and regulatory requirements for storing inventory 105. The AIOM 10 may further compensate for user shortcomings by providing the inventive concept with the capacity to monitor itself or its environment via sensors 170.

FIGS. 1 and 3 further illustrates a data queue 180 with inventory management tasks presenting selected operational performance thresholds 308 wherein the decision to change inventory levels within one or more operational cycles considers at least the cost and benefit of changing inventory levels to one or more selected levels of change compared to the cost and consequences of leaving inventory levels unchanged, the data queue 180 further designed to be used to arrange inventory management tasks based either or both on changing individual inventory item levels and changing substantially together levels of two or more inventory items 105.

FIG. 1 further illustrates a machine learning program 190 which supports the inventory management program 110 and is designed to, on a substantially continual cycle, at least one or more of further assess data from the data queue 180 and operational performance thresholds 308, recommend inventory management changes to either or both at least one human or at least one machine, monitor inventory management actions taken from recommendations by the at least one or more of the at least one human and the at least one machine, wherein the machine learning program 190 adapts its performance to improve the cost, pace, and quality of inventory management performance by optimizing inventory level changes to handle deviations from inventory use predictions, improving the accuracy of inventory use predictions, and recommending inventory use promotions whereby changes in inventory use requests improve prediction accuracy. Use of promotions strategies in some embodiments allow the AIOM 10 to seek a better result by using another way besides inventory replenishment to improve control of the inventive concept.

In some embodiments, assessments of inventory occur periodically wherein the assessments by the machine learning program 190 happen as needed at given intervals, the result being to minimize data processing required by the at least one computer 200, with the aim to process inventory data only as often as required for the AIOM to optimize results.

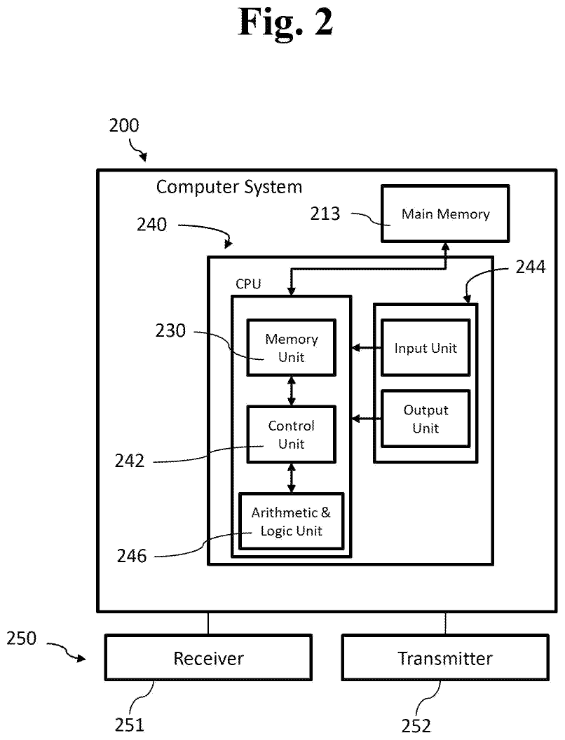

FIG. 2 illustrates an exemplary AIOM computer processor central processing unit (CPU) 240, also called a central processor or main processor, which is the electronic circuitry within the representative at least one computer 200 that executes instructions that make up a computer program. The CPU 240 performs basic arithmetic, logic, controlling, and input/output (I/O) operations specified by the instructions in the program. An arithmetic & logic unit (ALU) 246 is a combination digital electronic circuit that performs arithmetic and bitwise operations in integer binary numbers. Traditionally, the term CPU 240 refers to a processor, more specifically to its processing unit and control unit (CU) 242, distinguishing these core elements of a computer from external components such as main memory 213 and input output (I/O) circuitry 244. A CPU 240 may also contain memory 230. Memory 230 refers to a component that is used to store data for immediate use in a computer 200. A wireless interconnection system 250 including at least one receiver 251 and transmitter 252 is operationally coupled to the at least one central processing unit (CPU) 240 having the at least one memory unit 230.

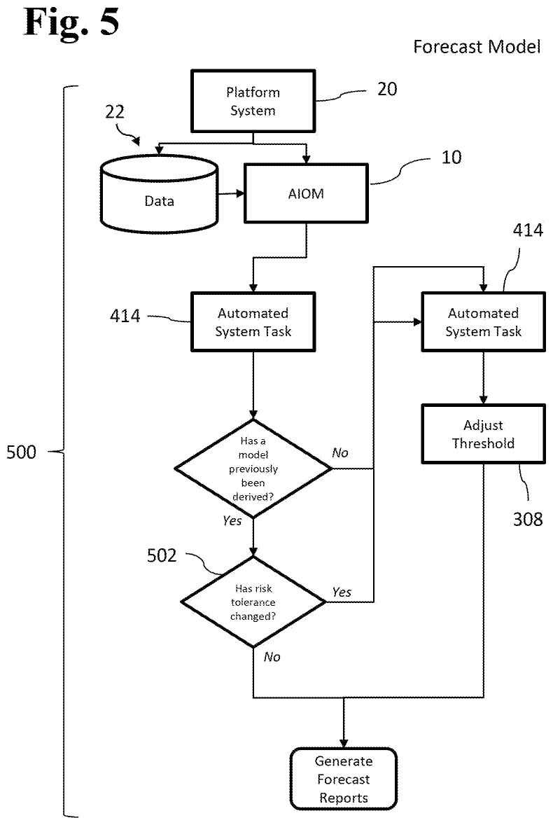

FIG. 3 illustrates an exemplary AIOM Controls schematic 300 with representative variables 310 such as, but not limited to, inventory identification, importance weights, and goal optimization settings. For ease of use, the given user is presented substantially with sliding bars 320 from which to change preferred outcomes for each variable. Sliding bars 320 allow users to seek more precise or varied possibilities than might be possible with an alternative embodiment, not shown, that defines specific intervals of change. Operational performance thresholds 308 may include adjustable threshold priorities of at least one or more of cost control versus availability, availability importance versus non-importance, frequency by which to permit non-availability, staffing, and, as illustrated in FIG. 5, risk tolerance 502 by which cost control and availability priorities may change.

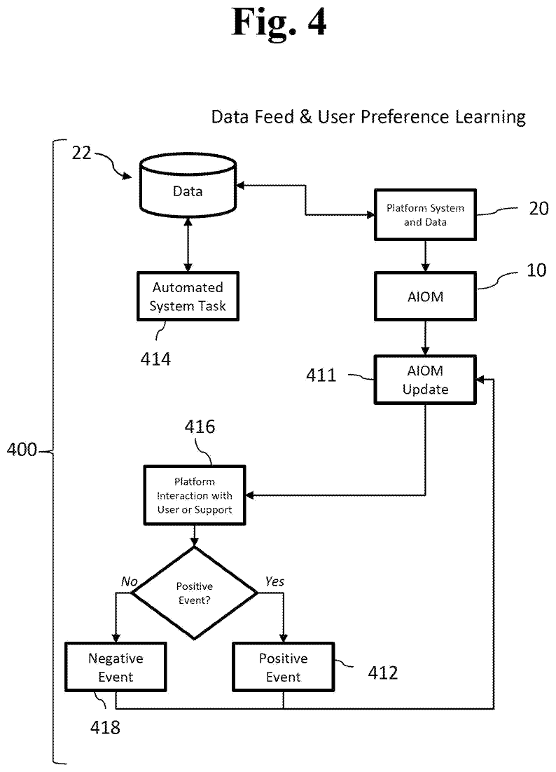

FIG. 4 illustrates an exemplary data feed and user preference 400 for AIOM machine learning and includes system and method elements of AIOM item 411 of the AIOM 10, positive event 412, automated system task 414, platform interaction with user support 416, negative event 418, and platform system 420.

FIG. 5 illustrates an exemplary forecasting model 500 with the addition of existing data 22, elements of which may provide data for the machine learning program 190 to support operations as well as data to train the machine learning program 190 and validate the machine learning program 190 results. A notification protocol to address deviations from performance thresholds 308 may be enacted by changing at least one or more of inventory levels, preparation of inventory, state of inventory, and staffing to one or more selected levels of change, the state of inventory to include at least one or more of thawing, mixing, cooking, and opening a seal wherein the conditions of the time, space, material, and risk associated with the associated inventory may change. A notification protocol may assess if changing inventor levels to one or more selected levels of change reduced deviations from performance thresholds 308, positive and negative results updated to the AIOM.

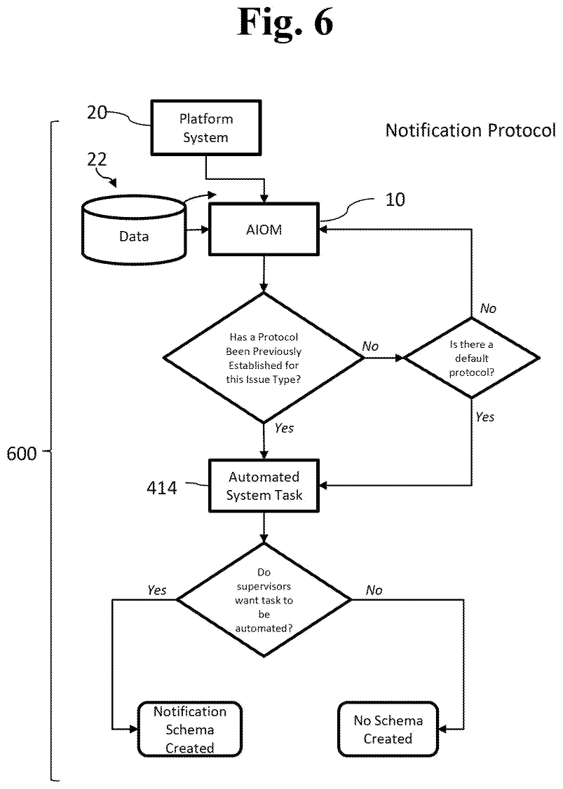

FIG. 6 illustrates an exemplary notification protocols process 600, which may include AIOM item 11 of the AIOM 10, positive event 412, automated system task 414, platform interaction with user support 416, negative event 18, platform system 20, and existing data 22. The adjustable threshold priorities adjusted by at least one or more of people and computers. The decisions to be made by which of the at least one or more of people and computers may also be adjustable.

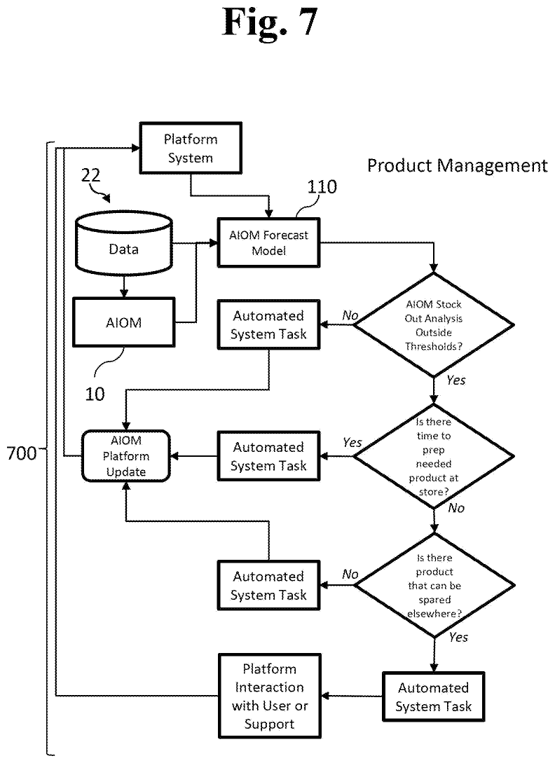

FIG. 7 illustrates an exemplary notification protocol 700 (intra-day), which may include AIOM item 411 of the AIOM 10, positive event 412, automated system task 414, platform interaction with user support 416, negative event 18, platform system 20, and existing data 22.

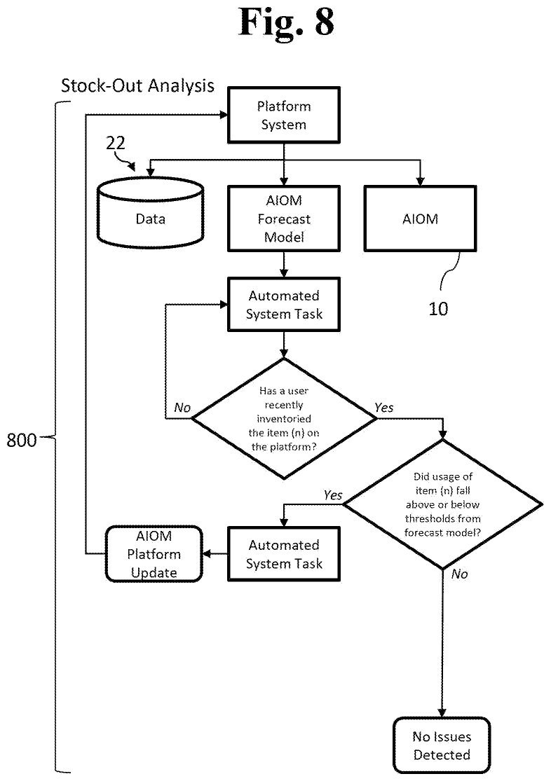

FIG. 8 illustrates an exemplary stock-out analysis 800, which may include AIOM item 411 of the AIOM 10, positive event 412, automated system task 414, platform interaction with user support 416, platform system 20, and existing data 22.

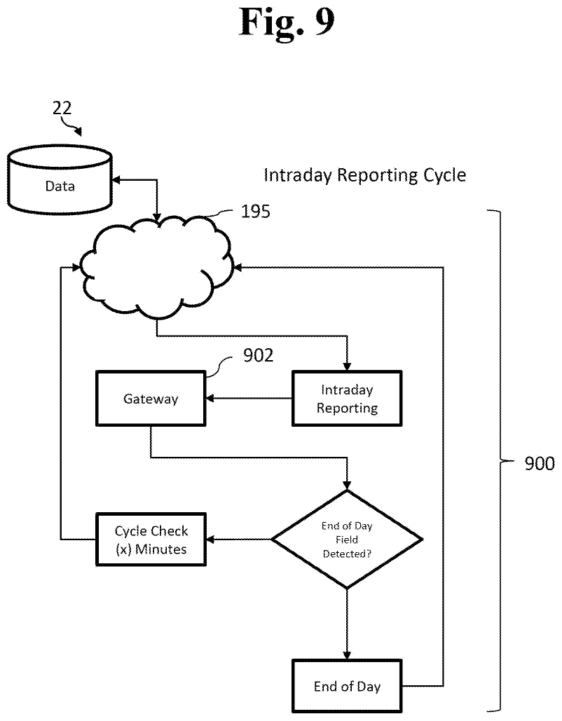

FIG. 9 illustrates an exemplary intra-day reporting schedule 900 via an Amazon API gateway 902. Other gateways may be used. Inter-day and end-of-day operational performance thresholds 308 may include adjustable threshold priorities of at least one or more of cost control versus availability

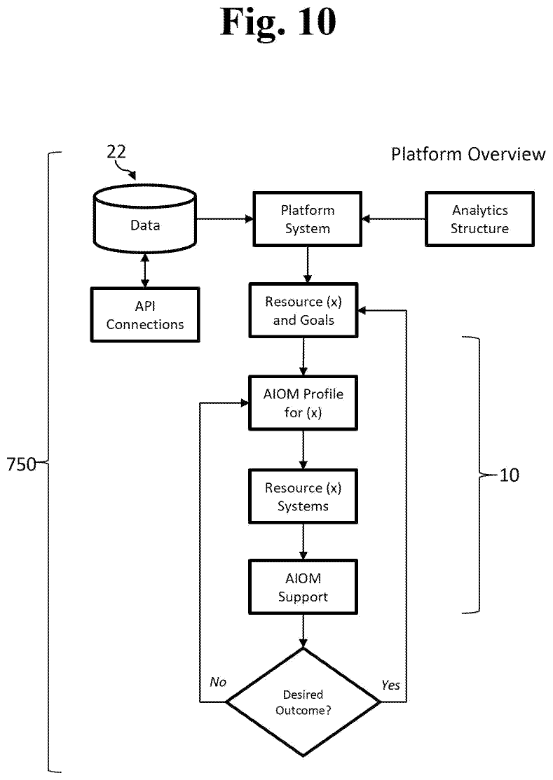

FIG. 10 illustrates an exemplary platform overview 750 that may include AIOM item 411 of the AIOM 10, positive event 412, automated system task 414, platform interaction with user support 416, negative event 18, platform system 20, and existing data 22.

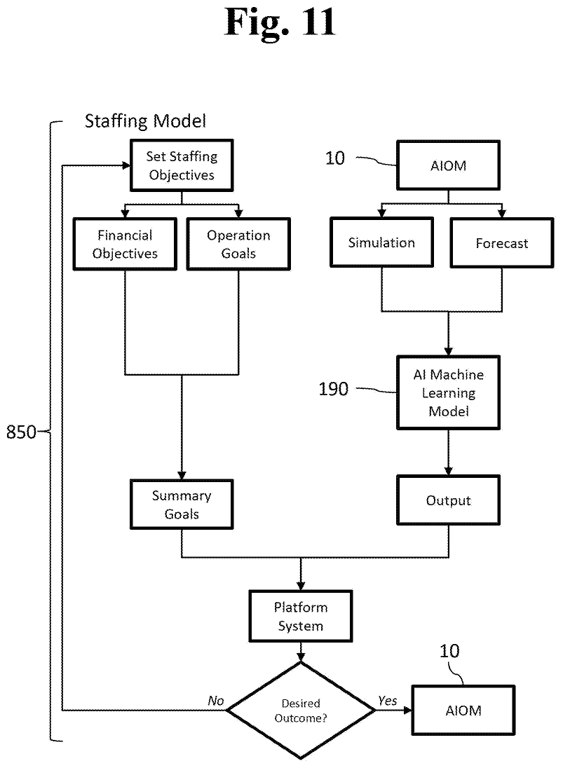

FIG. 11 illustrates an exemplary staffing model 850 that may include AIOM item 411 of the AIOM 10, positive event 412, automated system task 414, platform interaction with user support 416, negative event 18, platform system 20, and existing data 22.

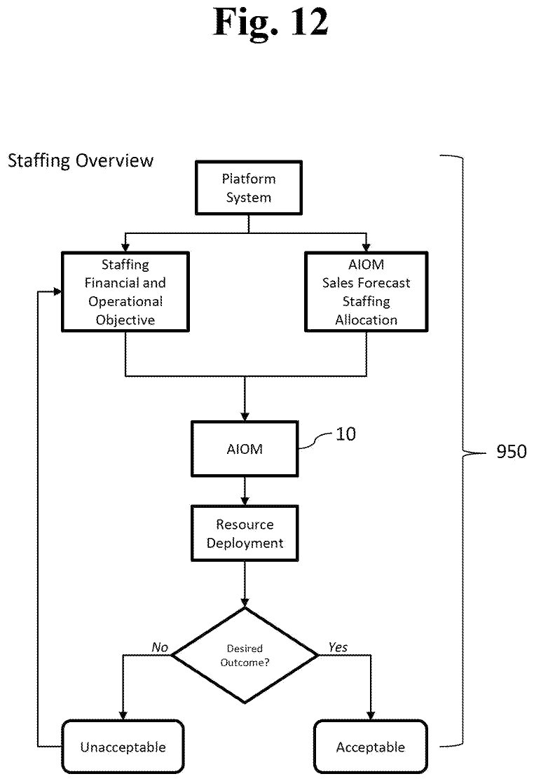

FIG. 12 illustrates an exemplary staffing overview 950, which may include AIOM item 411 of the AIOM 10, positive event 412, automated system task 414, platform interaction with user support 416, negative event 18, platform system 20, and existing data 22.

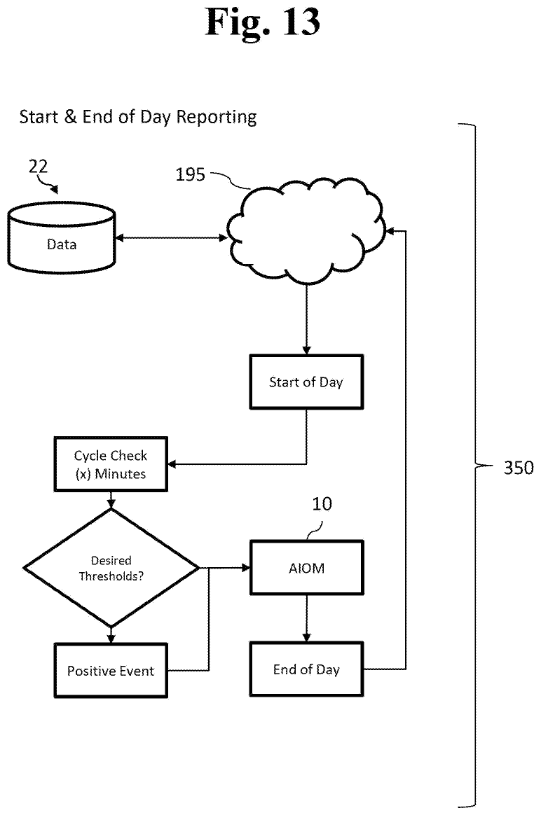

FIG. 13 illustrates an exemplary start and end day reporting 350, which may include AIOM item 411 of the AIOM 10, positive event 412, automated system task 414, platform interaction with user support 416, negative event 18, platform system 20, and existing data 22.

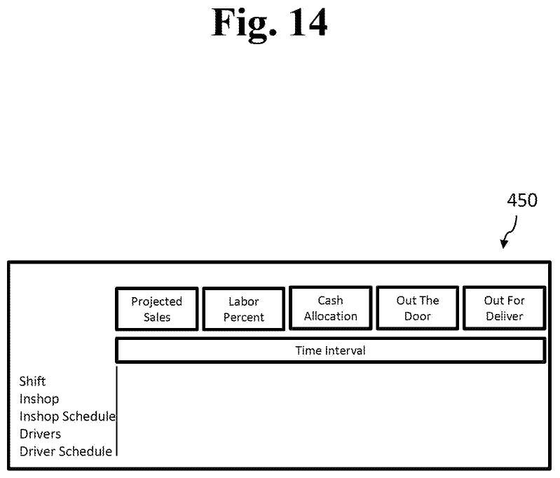

FIG. 14 illustrates an exemplary schedule output 450.

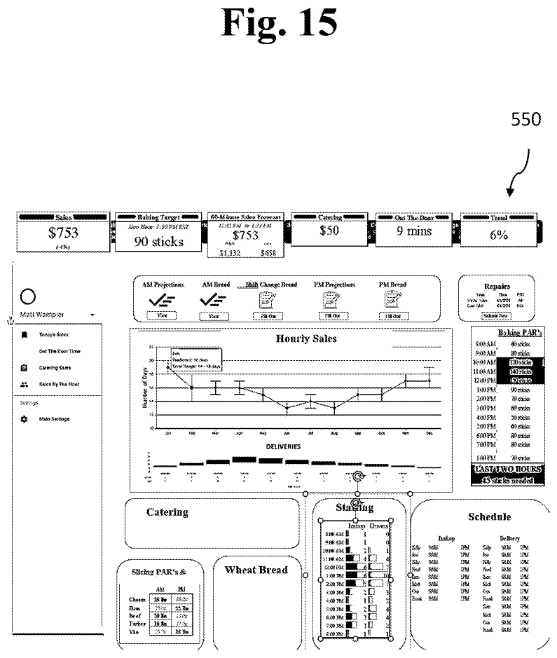

FIG. 15 illustrates an exemplary store manager dashboard 550. In one embodiment of the AIOM 10, a user may set operational goals via the store manager dashboard 550 through which to orient the inventory management program 110 and the associated machine learning program 190 wherein the selection of operational goals may be set either or both manually or machine assisted, and where the goals include, but are not limited to, controlling costs and optimizing inventory availability. Some embodiments of the store manager dashboard 550 include the sliding bars 320 by which to select operational goals. The sliding bars 320 add versatility to the inventive concept by giving users the capacity to produce more than one type or quality of result by adjusting the sliding bars 320. The dashboard 550 may use varied methods of making important data visible, including but not limited to alphanumeric symbols, location of data on the dashboard 550, use of symbols, shapes, flashes, colors, highlighted boarders, audibles, and other means known by those skilled in the art to draw attention to important updates and controls. The dashboard may have one or more screen views.

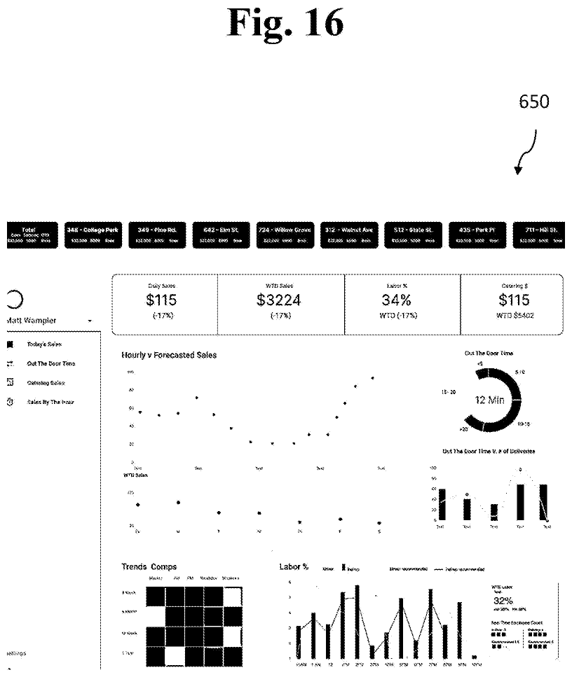

FIG. 16 illustrates an exemplary sales reporting output dashboard 650.

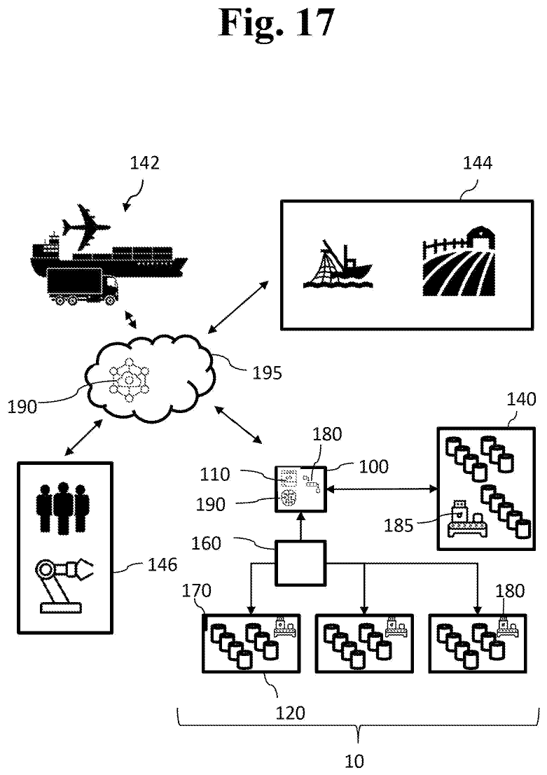

FIG. 17 illustrates one embodiment of the AIOM 10, the AIOM 10 further rendering controllable at least one or more equipment members 185, the equipment members 185 having at least one computer processor operable with a memory storage medium 100, the AIOM 10 designed to either or both control and advise on equipment member performance to further optimize the use of resources. One of ordinary skill in the art would recognize that equipment members may be a part of the Internet of Things (IoT) 190 supported by a cloud computer system 195. The IoT 190 describes the network of physical objects, so known as, “things,” which are embedded with sensors, software, and other technologies used to connect and exchange data with other devices and systems over the Internet. The AIOM 10 may use cloud computing 195 as a system and for methods of other operations besides IoT, including AI and machine learning. The AIOM 10 can, therefore, be networked beyond a single operational unit 120 to a plurality of operational units 120, equipment members 185 within those operational units 140, and may be further networked into logistics units 142, sources of supply 140, and sources of production 144, as well as to people and machines operating the same 146. The AIOM 10 may be partly or entirely on a cloud computer system 195. The AIOM 10 may be locally disposed on a computer system 100 within one or more operational units 120.

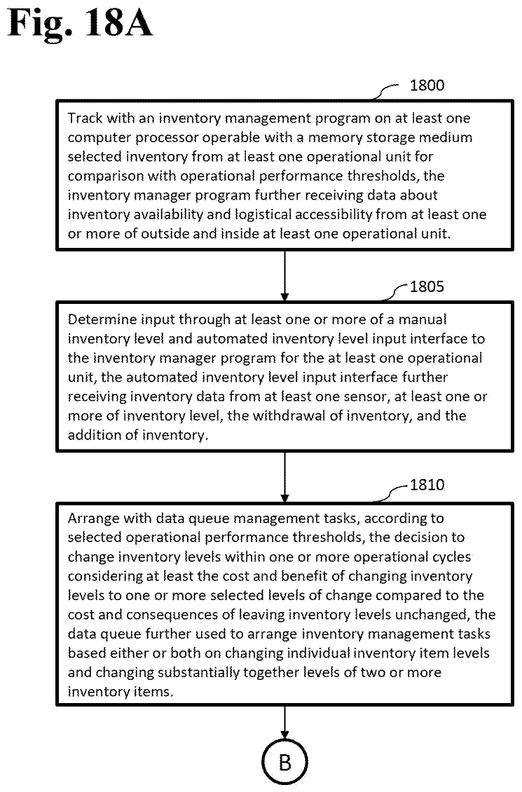

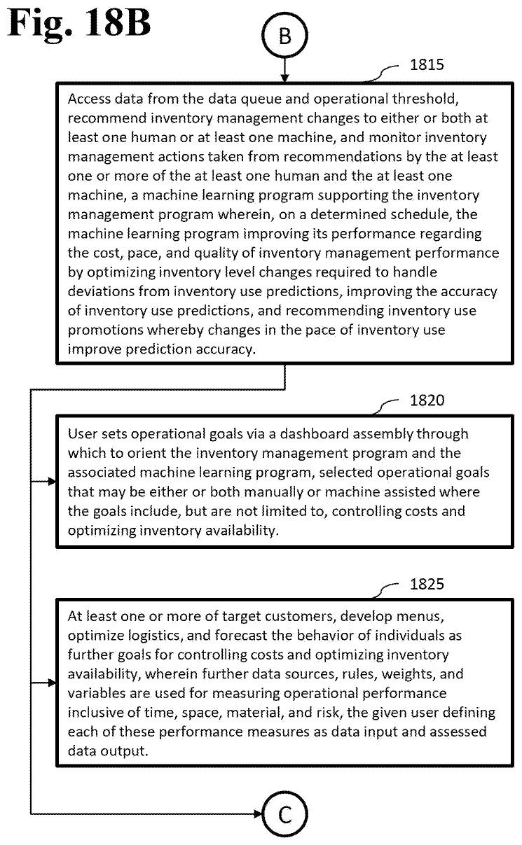

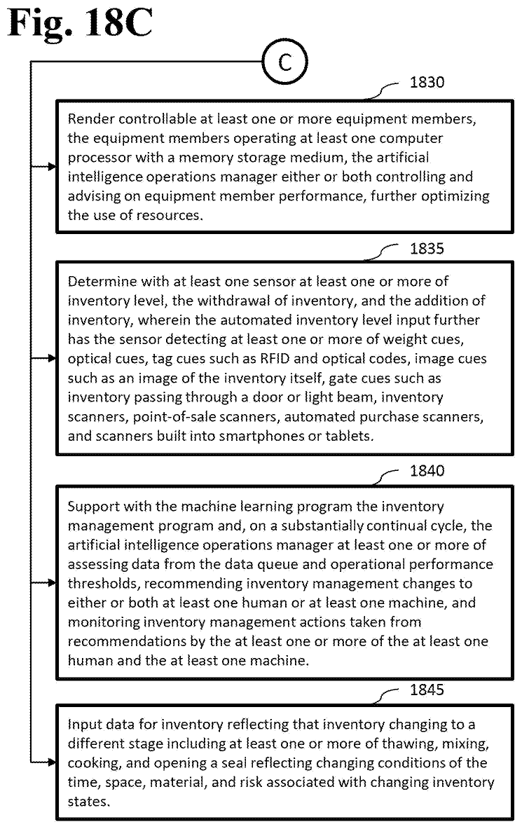

FIG. 18A-18C illustrates one representative method of the artificial intelligence operations manager AIOM 10 method, the method of 1800 including the step of tracking with the inventory management program 110 on at least one computer processor operable with the memory storage medium selected inventory from at least one operational unit 120 for comparison with operational performance thresholds 308, the inventory manager program 110 further receiving data about inventory availability and logistical accessibility from at least one or more of outside and inside at least one operational unit 120. The method further includes the step of 1805 determining through at least one or more of the manual inventory level and automated inventory level input interface 160 to the inventory manager program 110 for the at least one operational unit 120, the automated inventory level input interface 160 further receiving inventory data from at least one sensor 170, at least one or more of inventory level, the withdrawal of inventory, and the addition of inventory.

The method further includes the step of 1810 arranging with the data queue 180 management tasks according to selected operational performance thresholds 308, the decision to change inventory levels within one or more operational cycles considering at least the cost and benefit of changing inventory levels to one or more selected levels of change compared to the cost and consequences of leaving inventory levels unchanged, the data queue 180 further used to arrange inventory management tasks based either or both on changing individual inventory item levels and changing substantially together levels of two or more inventory items. The method further includes the step of 1815 at least one or more of accessing data from the data queue 180 and operational threshold, recommending inventory management changes to either or both at least one human or at least one machine, and monitoring inventory management actions taken from recommendations by the at least one or more of the at least one human and the at least one machine, the machine learning program 190 supporting the inventory management program 110 wherein, on a determined schedule, the machine learning program 190 improves its performance regarding the cost, pace, and quality of inventory management performance by optimizing inventory level changes required to handle deviations from inventory use predictions, improving the accuracy of inventory use predictions, and recommending inventory use promotions whereby changes in the pace of inventory use improve prediction accuracy.

The artificial intelligence operations manager AIOM 10 method may further include the step of 1820 the user setting operational goals via the dashboard assembly through which to orient the inventory management program 110 and the associated machine learning program 190 selecting operational goals may be either or both manually or machine assisted, and where the goals include, but are not limited to, controlling costs and optimizing inventory availability.

The artificial intelligence operations manager AIOM 10 method may further include the step of 1825 at least one or more of targeting customers, developing menus, optimizing logistics, and forecasting the behavior of individuals as further goals for controlling costs and optimizing inventory availability, wherein further data sources, rules, weights, and variables are used for measuring operational performance inclusive of time, space, material, and risk, the given user defining each of these performance measures as data input and assessed data output.

The artificial intelligence operations manager AIOM 10 method may further include the step of 1830 the artificial intelligence operations manager rendering controllable at least one or more equipment members, the equipment members operating at least one computer processor with the memory storage medium, the artificial intelligence operations manager AIOM 10 either or both controlling and advising on equipment member performance, further optimizing the use of resources.

The artificial intelligence operations manager AIOM 10 method may further include the step of 1835 at least one sensor 170 determining at least one or more of inventory level, the withdrawal of inventory, and the addition of inventory, wherein the automated inventory level input further has the sensor 170 detecting at least one or more of weight cues, optical cues, tag cues such as RFID and optical codes, image cues such as an image of the inventory itself, gate cues such as inventory passing through a door or light beam, inventory scanners, point-of-sale scanners, automated purchase scanners, and scanners built into smartphones or tablets.

The artificial intelligence operations manager AIOM 10 method may further include the step of 1840 the machine learning program 190 supporting the inventory management program 110 and, on a substantially continual cycle, the artificial intelligence operations manager at least one or more of assessing data from the data queue 180 and operational performance thresholds 308, recommending inventory management changes to either or both at least one human or at least one machine, and monitoring inventory management actions taken from recommendations by the at least one or more of the at least one human and the at least one machine.

The artificial intelligence operations manager AIOM 10 method may further include the step of 1845 the artificial intelligence operations manager inputting data for inventory reflecting that inventory to a different stage including at least one or more of thawing, mixing, cooking, and opening a seal reflecting changing conditions of the time, space, material, and risk associated with changing inventory states.

The following patents are incorporated by reference in their entireties: Pat. Nos. US2020247661, US2020192984, US2020143313, US2018165732, US2018158015, U.S. Ser. No. 11/004,034, U.S. Ser. No. 10/706,386, U.S. Ser. No. 10/373,117, U.S. Pat. Nos. 7,877,291, 7,644,863, KR20210023119, KR101939106, IN202011039146, CN112801823a, CN109961282a, CN105590248a.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An artificial intelligence operations manager system comprising:
at least one computer processor operable with a memory storage medium;
an inventory manager program that tracks selected inventory from at least one operational unit for comparison with operational performance thresholds, the inventory manager program further adapted to receive data about inventory availability and logistical accessibility from at least one or more of outside and inside at least one operational unit;
at least one or more of a manual inventory level and automated inventory level input interface to the inventory manager program for the at least one operational unit, the automated inventory level input interface further having at least one sensor determining at least one or more of inventory level, the withdrawal of inventory, and the addition of inventory;
a data queue used by the inventory management program to arrange inventory management tasks according to selected operational performance thresholds wherein the decision to change inventory levels within one or more operational cycles considers at least the cost and benefit of changing inventory levels to one or more selected levels of change compared to the cost and consequences of leaving inventory levels unchanged, the data queue further adapted to be used to arrange inventory management tasks based either or both on changing individual inventory item levels and changing substantially together levels of two or more inventory items; and
a machine learning program supporting the inventory management program adapted to, on a determined cycle, at least one or more of assess data from the data queue and operational threshold, recommend inventory management changes to either or both at least one human or at least one machine, monitor inventory management actions taken from recommendations by the at least one or more of the at least one human and the at least one machine, wherein the machine learning program adapts its performance to improve the cost, pace, and quality of inventory management performance by optimizing inventory level changes required to handle deviations from inventory use predictions, improving the accuracy of inventory use predictions, and recommending inventory use promotions whereby changes in the pace of inventory use improve prediction accuracy.

2. The artificial intelligence operations manager system of claim 1 wherein a user may set operational goals via a dashboard assembly through which to orient the inventory management program and the associated machine learning program wherein the selection of operational goals may be set either or both manually or machine assisted, and where the goals include, but are not limited to, controlling costs, and optimizing inventory availability.

3. The artificial intelligence operations manager system of claim 2 wherein goals for controlling costs and optimizing inventory availability are supported by further goals including, but not limited to, targeting customers, developing menus, optimizing logistics, and forecasting the behavior of individuals wherein further data sources, rules, weights, and variables pertain to operational performance measures inclusive of time, space, material, and risk as each of these performance measures are defined by the given user as data input and assessed data output.

4. The artificial intelligence operations manager system of claim 1 wherein the artificial intelligence operations manager further renders controllable at least one or more equipment members, the equipment members having at least one computer processor operable with a memory storage medium, the artificial intelligence operations manager adapted to either or both control and advise on equipment member performance to further optimize the use of resources.

5. The artificial intelligence operations manager system of claim 1 wherein the automated inventory level input further has the at least one sensor determining at least one or more of inventory level, the withdrawal of inventory, and the addition of inventory, wherein the sensor detects at least one or more of weight cues, optical cues, tag cues such as RFID and optical codes, image cues such as an image of the inventory itself, gate cues such as inventory passing through a door or light beam, inventory scanners, point-of-sale scanners, automated purchase scanners, and scanners built into smartphones or tablets.

6. The artificial intelligence operations manager system of claim 1 wherein a machine learning program supports the inventory management program and is designed to, on a substantially continual cycle, at least one or more of assesses data from the data queue and operational performance thresholds, recommends inventory management changes to either or both at least one human or at least one machine, and monitors inventory management actions taken from recommendations by the at least one or more of the at least one human and the at least one machine.

7. The artificial intelligence operations manager system of claim 1 wherein the artificial intelligence operations manager is adapted to input data for inventory to reflect that inventory moving to a different stage to include at least one or more of thawing, mixing, cooking, and opening a seal wherein the conditions of the time, space, material, and risk associated with the associated inventory may change.

8. An artificial intelligence operations manager method comprising:
tracking with an inventory management program on at least one computer processor operable with a memory storage medium selected inventory from at least one operational unit for comparison with operational performance thresholds, the inventory manager program further receiving data about inventory availability and logistical accessibility from at least one or more of outside and inside at least one operational unit;
determining through at least one or more of a manual inventory level and automated inventory level input interface to the inventory manager program for the at least one operational unit, the automated inventory level input interface further receiving inventory data from at least one sensor, at least one or more of inventory level, the withdrawal of inventory, and the addition of inventory;
arranging with data queue management tasks, according to selected operational performance thresholds, the decision to change inventory levels within one or more operational cycles considering at least the cost and benefit of changing inventory levels to one or more selected levels of change compared to the cost and consequences of leaving inventory levels unchanged, the data queue further used to arrange inventory management tasks based either or both on changing individual inventory item levels and changing substantially together levels of two or more inventory items; and
at least one or more of accessing data from the data queue and operational threshold, recommending inventory management changes to either or both at least one human or at least one machine, and monitoring inventory management actions taken from recommendations by the at least one or more of the at least one human and the at least one machine, a machine learning program supporting the inventory management program wherein, on a determined schedule, the machine learning program improves its performance regarding the cost, pace, and quality of inventory management performance by optimizing inventory level changes required to handle deviations from inventory use predictions, improving the accuracy of inventory use predictions, and recommending inventory use promotions whereby changes in the pace of inventory use improve prediction accuracy.

9. The artificial intelligence operations manager method of claim 8, the method including a user setting operational goals via a dashboard assembly through which to orient the inventory management program and the associated machine learning program selecting operational goals may either or both manually or machine assisted, and where the goals include, but are not limited to, controlling costs and optimizing inventory availability.

10. The artificial intelligence operations manager method of claim 9, the method further including at least one or more of targeting customers, developing menus, optimizing logistics, and forecasting the behavior of individuals as further goals for controlling costs and optimizing inventory availability, wherein further data sources, rules, weights, and variables are used for measuring operational performance inclusive of time, space, material, and risk, the given user defining each of these performance measures as data input and assessed data output.

11. The artificial intelligence operations manager method of claim 8, the method further including the artificial intelligence operations manager rendering controllable at least one or more equipment members, the equipment members operating at least one computer processor with a memory storage medium, the artificial intelligence operations manager either or both controlling and advising on equipment member performance, further optimizing the use of resources.

12. The artificial intelligence operations manager method of claim 8, the method further including at least one sensor determining at least one or more of inventory level, the withdrawal of inventory, and the addition of inventory, wherein the automated inventory level input further has the sensor detecting at least one or more of weight cues, optical cues, tag cues such as RFID and optical codes, image cues such as an image of the inventory itself, gate cues such as inventory passing through a door or light beam, inventory scanners, point-of-sale scanners, automated purchase scanners, and scanners built into smartphones or tablets.

13. The artificial intelligence operations manager of claim 8, the method further including the machine learning program supporting the inventory management program and, on a substantially continual cycle, the artificial intelligence operations manager at least one or more of assessing data from the data queue and operational performance thresholds, recommending inventory management changes to either or both at least one human or at least one machine, and monitoring inventory management actions taken from recommendations by the at least one or more of the at least one human and the at least one machine.

14. The artificial intelligence operations manager method of claim 8, the method further including the artificial intelligence operations manager inputting data for inventory reflecting that inventory to a different stage including at least one or more of thawing, mixing, cooking, and opening a seal reflecting changing conditions of the time, space, material, and risk associated with changing inventory states.

15. An artificial intelligence operations manager system comprising:
at least one computer processor operable with a memory storage medium;
an inventory manager program that tracks selected inventory from at least one operational unit for comparison with operational performance thresholds, the inventory manager program further adapted to receive data about inventory availability and logistical accessibility from at least one or more of outside and inside at least one operational unit, the inventory manager program further presentable as a dashboard having one or more screen views;
at least one or more of a manual inventory level and automated inventory level input interface to the inventory manager program for the at least one operational unit, the automated inventory level input interface further having at least one sensor determining at least one or more of inventory level, the withdrawal of inventory, and the addition of inventory;
a data queue used by the inventory management program to arrange inventory management tasks according to selected operational performance thresholds wherein the decision to change inventory levels within one or more operational cycles considers at least the cost and benefit of changing inventory levels to one or more selected levels of change compared to the cost and consequences of leaving inventory levels unchanged, the data queue further adapted to be used to arrange inventory management tasks based either or both on changing individual inventory item levels and changing substantially together levels of two or more inventory items;
inter-day and end-of-day operational performance thresholds including adjustable threshold priorities of at least one or more of cost control versus availability, availability importance versus non-importance, frequency by which to permit non-availability, staffing, and risk tolerance by which cost control and availability priorities may change, the adjustable threshold priorities adjusted by at least one or more of people and computers, the decisions to be made by which of the at least one or more of people and computers also adjustable;
a notification protocol to address deviations from performance thresholds by changing at least one or more of inventory levels, preparation of inventory, state of inventory, and staffing to one or more selected levels of change, the state of inventory to include at least one or more of thawing, mixing, cooking, and opening a seal wherein the conditions of the time, space, material, and risk associated with the associated inventory may change;
a notification protocol to assess if changing inventor levels to one or more selected levels of change reduced deviations from performance thresholds, positive and negative results updated to the artificial intelligence operations manager; and
a machine learning program supporting the inventory management program adapted to, on a determined cycle, at least one or more of assess data from the data queue and operational threshold, recommend inventory management changes to either or both at least one human or at least one machine, monitor inventory management actions taken from recommendations by the at least one or more of the at least one human and the at least one machine, wherein the machine learning program adapts its performance to improve the cost, pace, and quality of inventory management performance by optimizing inventory level changes required to handle deviations from inventory use predictions, improving the accuracy of inventory use predictions, and recommending inventory use promotions whereby changes in the pace of inventory use improve prediction accuracy.

16. The artificial intelligence operations manager system of claim 15, wherein goals for controlling costs and optimizing inventory availability are supported by further goals including, but not limited to, targeting customers, developing menus, optimizing logistics, and forecasting the behavior of individuals wherein further data sources, rules, weights, and variables pertain to operational performance measures inclusive of time, space, material, and risk as each of these performance measures are defined by the given user as data input and assessed data output.

17. The artificial intelligence operations manager system of claim 15, wherein the artificial intelligence operations manager further renders controllable at least one or more equipment members, the equipment members having at least one computer processor operable with a memory storage medium, the artificial intelligence operations manager adapted to either or both control and advise on equipment member performance to further optimize the use of resources.

18. The artificial intelligence operations manager system of claim 15, wherein the automated inventory level input further has the at least one sensor determining at least one or more of inventory level, the withdrawal of inventory, and the addition of inventory, wherein the sensor detects at least one or more of weight cues, optical cues, tag cues such as RFID and optical codes, image cues such as an image of the inventory itself, gate cues such as inventory passing through a door or light beam, inventory scanners, point-of-sale scanners, automated purchase scanners, and scanners built into smartphones or tablets.

19. The artificial intelligence operations manager system of claim 15, wherein machine learning program supports the inventory management program and is designed to, on a substantially continual cycle, at least one or more of assesses data from the data queue and operational performance thresholds, recommends inventory management changes to either or both at least one human or at least one machine, and monitors inventory management actions taken from recommendations by the at least one or more of the at least one human and the at least one machine.

20. The artificial intelligence operations manager system of claim 15, wherein at least one or more Internet of Things (IoT) networked sensors may communicate inventory use information to the artificial intelligence operations manager system.
